(19) United States
(12) Patent Application Publication
(10) Pub. No.: US 2015/0286667 A1
(43) Pub. Date: Oct. 8, 2015

(54) Systems and Methods for Using Listing Proximities to Improve Entity Listings

(71) Applicant: Google Inc., Mountain View, CA (US)

(72) Inventors: Ashutosh Kulshreshtha, San Jose, CA (US); Brian Eric Smartt, Sunnyvale, CA (US)

(21) Appl. No.: 13/929,133

(22) Filed: Jun. 27, 2013

(51) Int. Cl. G06F 17/30

(52) U.S. Cl. CPC G06F 17/30345

(57) ABSTRACT

Provided are methods and systems for improving entity listings. A cluster of listings having geographic proximity is determined and various evaluations of the listings in the cluster are performed. An attribute associated with a selected listing of the cluster may be compared to one or more attributes of the other listings and may be modified based on the comparison. Additionally, a census of the listings in the cluster may be performed and the cluster may be classified based on the census. A category associated with a selected listing may be modified based on the classification of the cluster.

### BACKGROUND OF THE INVENTION

1. Field of the Invention

This invention relates generally to computer-implemented geographic maps and, more particularly, to improving listing data in computer-implemented geographic maps.

2. Description of the Related Art

The Internet is useful for a variety of purposes. For example, users may use the Internet to retrieve information about businesses or other entities located near the user. For example, a user may view listings of entities in a geographic area, such as by searching a computer-implemented geographic map for listings of interest. Although information about entities may be generally available in some form, the information in listings of a geographic map may be inaccurate, incomplete, or out-of-date. Additionally, the information may not adequately describe a listing relative to other listings nearby in the geographic area. Consequently, a user may make incorrect decisions based on the inaccurate, incomplete, or out-of-date information. For example, a user may intend to visit a residence and instead find a commercial entity, or vice-versa. Moreover, the users may view the listing information as unreliable and may no longer use the computer-implemented geographic map providing the listings.

### SUMMARY OF THE INVENTION

Various embodiments of methods and systems for improving listings of a computer-implemented geographic map are provided herein. In some embodiments, a computer-implemented method for improving entity listings is provided that includes determining, by one or more processors, a cluster of a plurality of listings having geographic proximity and obtaining, by one or more processors, an attribute associated with a selected listing of the cluster. The method further includes comparing, by one or more processors, the attribute of the selected listing to one or more attributes of the other listings of the cluster and modifying, by one or more processors, a value of the attribute associated with the selected listing of the cluster based on the comparison.

In some embodiments, a system for improving entity listings is provided. The system includes one or more processors and a tangible non-transitory computer-readable storage medium accessible by the one or more processors and having executable computer code stored thereon, the code comprising a set of instructions that causes one or more processors to perform the following: determining, by one or more processors, a cluster of a plurality of listings having geographic proximity and obtaining, by one or more processors, an attribute associated with a selected listing of the cluster. The code further includes a set of instructions that causes one or more processors to perform the following: comparing, by one or more processors, the attribute of the selected listing to one or more attributes of the other listings of the cluster and modifying, by one or more processors, a value of the attribute associated with the selected listing of the cluster based on the comparison

Additionally, in some embodiments, a computer-implemented method for improving entity listings is provided that includes determining, by one or more processors, a cluster of a plurality of listings having geographic proximity and obtaining a census of listings in the cluster. Additionally, the method includes classifying the cluster into a class based on the census of listings and storing information about each listing in the cluster of listings based on the class of the cluster.

In some embodiments, a system for improving entity listings is provided. The system includes one or more processors and a tangible non-transitory computer-readable storage medium accessible by the one or more processors and having executable computer code stored thereon, the code comprising a set of instructions that causes one or more processors to perform the following: determining, by one or more processors, a cluster of a plurality of listings having geographic proximity on a computer-implemented geographic map and obtaining a census of listings in the cluster. Additionally, the code further includes a set of instructions that causes one or more processors to perform the following: classifying the cluster into a class based on the census of listings and storing information about each listing in the cluster of listings based on the class of the cluster.

### BRIEF DESCRIPTION OF THE DRAWINGS

FIG. 1 is a block diagram of a process for using listing proximities to improve listings of a computer-implemented geographic map in accordance with an embodiment of the present invention;

FIG. 2 is a block diagram of another process for using listing proximities to improve listings of a computer-implemented geographic map in accordance with another embodiment of the present invention;

FIG. 3 is a schematic diagram of a portion of a geographic map that depicts listing clusters in accordance with an embodiment of the present invention;

FIG. 4 is a block diagram of a system for using listing proximities to improve listings of a computer-implemented geographic map in accordance with an embodiment of the present invention; and

FIG. 5 is a block diagram of a computer in accordance with an embodiment of the present invention.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

As discussed in more detail below, provided in some embodiments are systems and methods for improving listings of a computer-implemented geographic map. In some embodiments, a cluster of listings is determined from listing locations in a geographic area. The listings of a cluster are determined based the proximity of listings to each other. Selected listings of the cluster are then evaluated based on other listings of the cluster. In some embodiments, the attribute of a selected listing is compared to attributes of other listings in the cluster. Based on the comparison, the attribute of the selected listing may be updated to match the attributes of the other listings in the cluster. In some embodiments, inter-listing relationships may be modified based on the listings of a cluster. Additionally, in some embodiments, a category of a listing is compared to the categories of other listings in the cluster. Based on the comparison, a listing may be identified as a suspect listing and flagged for further review.

In some embodiments, a census of listings of a cluster is performed. The cluster is classified based on the census. Information about listings in the cluster may be determined and stored based on the classification of the cluster. Additionally, in some embodiments, the category of a selected listing in the cluster is compared to the classification of the cluster. Based on the comparison, the category of the selected listing may be modified or the selected listing may be flagged for further review.

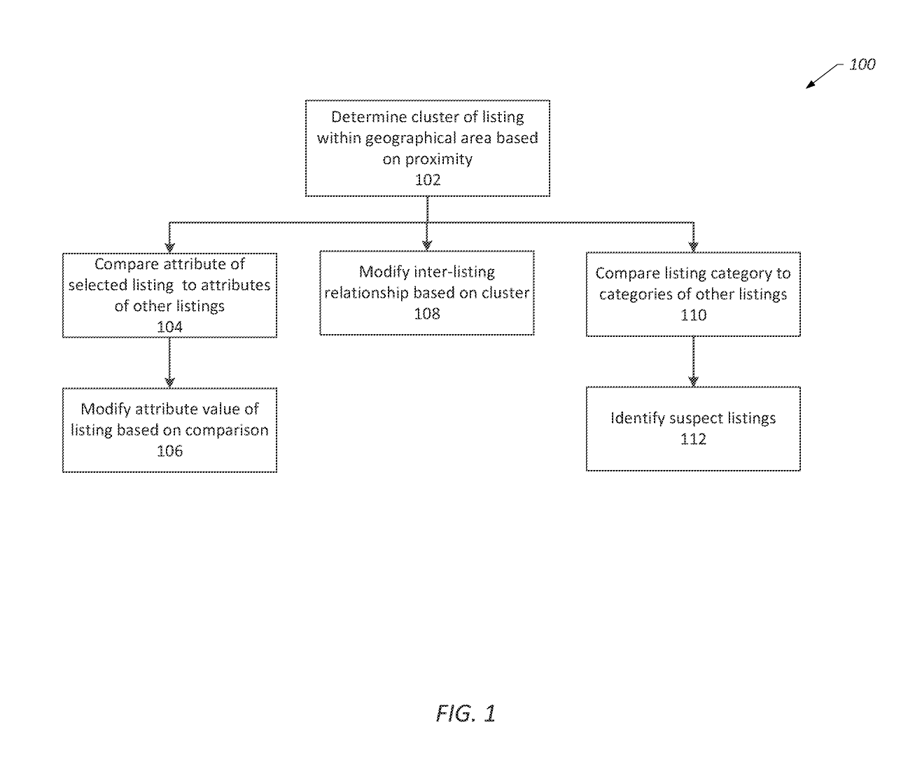

FIG. 1 depicts a process 100 for using listing proximities to improve listings of a computer-implemented geographic map in accordance with an embodiment of the present invention. Some or all steps of the process 100 may be implemented as executable computer code stored on a non-transitory tangible computer-readable storage medium and executed by one or more processors of a special-purpose machine, e.g., a computer programmed to execute the code. Initially, a unit of listing within a geographical area is determined (block 102) based on proximity of the listings to each other. As used herein, a “cluster” refers to the unit of proximal listings used for subsequent analysis. The listings may include listings for entities, such as residential entities or commercial entities, and listings for geographic features, such as bodies of water, mountains, artificial or natural borders, roads, and other geographic features. An entity may include, for example, a residence, a commercial entity such as a business, a public entity such as a government office, park, public transportation entity (e.g., a bus stop, subway station, etc.) or other public entity, and the like. A cluster of listings may be determined by different techniques that evaluate the listings and their proximity to each other. In some embodiments, the cluster is determined by evaluating listings within a radius of a geographic point. In other embodiments, the cluster is determined by evaluating listings within a unit (e.g., a cell) of a computer-implemented geographic map that is divided into units. In some embodiments, a cluster is determined by placing a node at each unique listing in the geographic area and drawing edges between each pair of nodes that are within a distance threshold. The graph structure is analyzed to determine connected components, such that each connected component is identified as a cluster of listings. Thus, a relatively smaller distance threshold in a dense area may result in a large number of clusters.

Various actions may be performed based on an identified cluster. In some embodiments, the attribute of a selected listing of the cluster is compared to other listings of the cluster (block 104). Attributes may include various characteristics of a listing, such as whether a listing may be visited in person (referred to herein as “visitability”). Based on the comparison, the attribute of the selected listing can be modified to match the attribute of the other listings of the cluster (block 106). Using the example attribute described above, if a selected listing for a professional (e.g., a realtor) is compared to other listings in the cluster, none of which are “visit-able,” the attribute of the selected listing may be changed to indicate the listing is not “visit-able.” For example, if the selected listing is a professional working out of his or her home, it is likely that the listing is not “visti-able.” By comparing the “visitability” of the listing to other listings in the cluster, all of which have residential attributes and are not “visit-able,” the attribute of the selected listing can be updated to indicate that the listing is not “visit-able.” In contrast, if the selected listing is for a professional working out of an office in a commercial complex, the other listings in the identified cluster will likely be “visit-able” and the attribute of the selected listing can be maintained as “visit-able.” Other attributes may include whether a listing is open during the day, whether a listing is open during the night, whether a listing requires membership to visit, or whether a listing has other restrictions for visiting (e.g., age restrictions, pet restrictions, etc.).

In some embodiments, an inter-listing relationship is modified based on the cluster (block 108). In such embodiments, relationships between listings may be defined and used to provide more accurate information about a listing. For example, an ATM, may have a physical relationship to a grocery store listing (e.g., the ATM may be located inside the grocery store). The inter-listing relationship between the ATM listing and grocery store listing can be modified to indicate that the ATM is located inside the grocery store. Thus, if certain selected listings of a cluster (e.g., an ATM, a bank, etc.) have the same address as a store listing in the cluster, the listing relationship between the selected listings and the store listing may be modified to indicate that the selected listings are located inside the store. In some embodiments, the inter-listing relationship may be based on a density of the cluster of listings. A density of the listings in the cluster may be determined (e.g., based on distances between listings) and the inter-listing relationship between a selected listing of the cluster and another listing may be modified based on the density.

Additionally, in some embodiments, a category of selected listing is compared to the categories of other listings in the cluster (block 110). Listing categories may include, for example, “residential”, “commercial”, “retail,” “medical”, “public”, “food and drink”, “banking”, “industrial,” or any other suitable categories. The category of a selected listing is compared to the categories of other listings in the cluster to determine if the category matches or is different than the other categories. Based on the comparison, suspect listings are identified and flagged for further analysis (block 112). In some embodiments, if the category of a selected listing differs from a specified percentage or number of other listings in a cluster, the selected listing may be flagged as a suspect listing. For example, if a retail store listing is clustered with medical listings, it could indicate that the store has been replaced with a medical office building. In some embodiments, suspect listings may be reviewed by an operator and subjected to additional category verification actions (e.g., directly contacting the business).

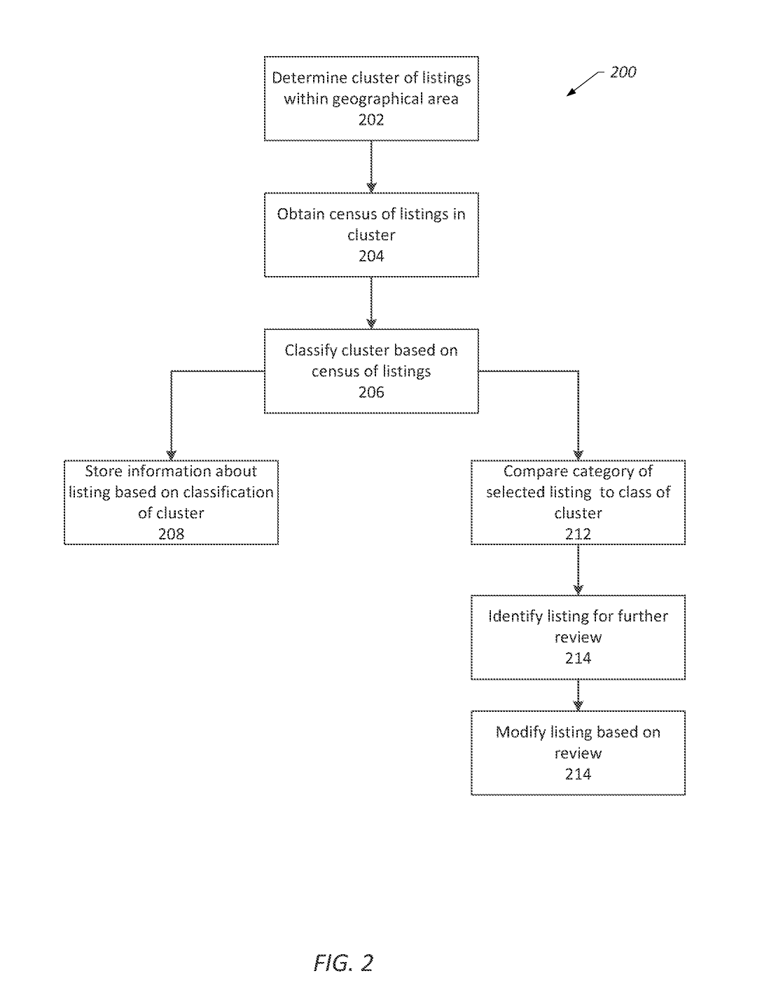

In some embodiments, a census is performed of the listings in a cluster and the cluster is classified based on the census. FIG. 2 depicts a process 200 for using listing proximities to improve listings of a computer-implemented geographic map in accordance with another embodiment of the present invention. Some or all steps of the process 200 may be implemented as executable computer code stored on a non-transitory tangible computer-readable storage medium and executed by one or more processors of a special-purpose machine, e.g., a computer programmed to execute the code. Initially, a cluster of unique listings within a geographic area is determined (block 202). As described above, a cluster may be determined be evaluating the listings and their proximity to each other, such as by evaluating listings within a radius of a geographic point, evaluating listings within a unit (e.g., a cell) of a computer-implemented map, determining and evaluating a node graph structure.

Next, a census of listings within the cluster is performed (block 204). In some embodiments, the census is performed to determine categories of the listings within the cluster. In some embodiments, such categories may include, for example, “residential”, “commercial”, “retail,” “medical”, “public”, “food and drink”, “banking”, “industrial,” or any other suitable categories.

The cluster of listings is classified based on the census of listings (block 206). For example, if all or most of the listings in a cluster belong to a “commercial” category, then the cluster may be classified as “commercial.” Similarly, if all or most of the listings belong to a “residential” category, the cluster may be classified as “residential.” In some embodiments, the cluster may be classified based on the categories of a threshold number or percentage of listings of the cluster. After classifying the cluster, the classification may be used to improve processing and information associated with the listings of the cluster. For example, listings in a “retail” cluster may be processed differently than listings in a “medical” cluster.

In some embodiments, information about listings is stored based on the classification of the cluster (block 208). For example, a first set of information may be stored for listings in a cluster of mostly retail stores and restaurants, while a second set of different information may be stored for listings in a cluster of medical clinics, pharmacies and labs. In some embodiments, the information includes display information (e.g., how the listings of a cluster are displayed on a geographic map), search result information (e.g., how the listings of a cluster are presented in search results), and other types of information.

In some embodiments, a category or attributes associated with some listings of the cluster are evaluated based on the classification of the cluster. Such attributes may include, for example, the visitability attribute described above. Other attributes may include entrance information (e.g., whether an entrance is a common entrance for all listings in the cluster), shared parking (e.g., whether a parking lot is shared among entities of a cluster), operating hours (e.g., whether an entity located inside another entity shares the same operating hours), and so on. The attribute of a selected listing of the cluster may be compared to the classification of the cluster (block 212). In some embodiments, the selected listing is flagged for further review (block 214), such as manual review (e.g., by an operator) or automatic review, if its attributes are inconsistent with the classification of the cluster. Based on the review, the listing may be modified (block 216).

As mentioned above, it should be appreciated that listings may also include geographic features. For example, a lake and a park may belong to a cluster, and the attributes of the park may be learned based on the attributes of the lake (e.g., whether the park rents water-related equipment or offers water-related services). In another example, a road and a bus stop may belong to a cluster, and information about the road, bus stop, or both may be stored based on the classification of the cluster.

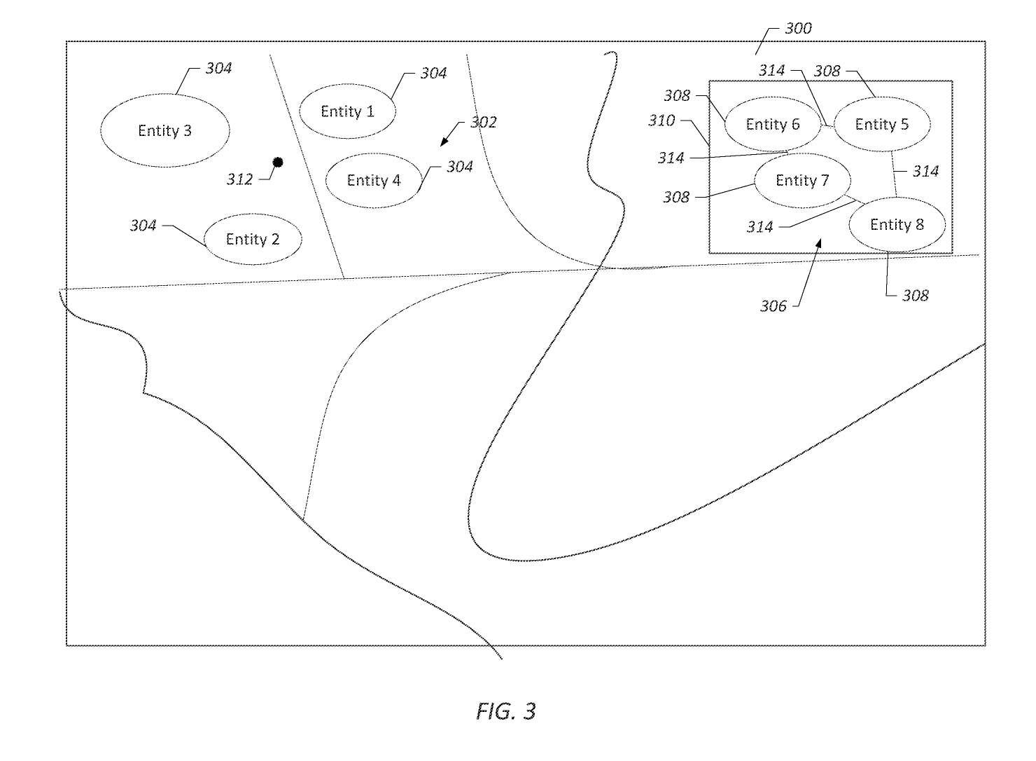

FIG. 3 depicts a portion 300 of a geographic map that illustrates clustering of listings as described above and in accordance with an embodiment of the present invention. As shown in the figure, a first cluster 302 of listings 304 may include, for example, Entity 1, Entity 2, Entity 3, and Entity 4. Additionally, a second cluster 306 of listings 308 may include Entity 5, Entity 6, Entity 7, and Entity 8. The clusters 302 and 306 may each include the same or different types of listings. For example, the cluster 302 may be a cluster of residential listings and the cluster 306 may be a cluster of commercial listings. In another example, Entity 1, Entity 2, and Entity 3 may be residential entities and Entity 4 may be a commercial entity. Similarly, in another example, Entity 5, Entity 6, and Entity 7 may be medical entities and Entity 8 may be a retail store entity. Additionally, the listings need not be grouped in the same physical structure. For example, the listings of cluster 302 may represent separate and discreet physical structures, such as different houses. Alternative, the listings of cluster 302 may share the same physical structure, such as condominium building. Similarly, the listings of the commercial cluster 306 may represent separate and discreet physical structures or may be a part of single physical structure, such as a shopping mall or office building.

To identify a cluster, the proximity of the listings may be evaluated and clusters determined based on the techniques described above. For example, in some embodiments, the cluster 302 is identified based on the distance of the listings 304 from a point 312 on the geographic map portion 300. In some embodiments, as mentioned above, a cluster is identified by evaluating listings within a unit of a geographic map. For example, the listings 308 may be located within a unit 310 of the geographic map portion. A graph of the listings can be generated where a node is placed at each listing and edges 314 are drawn between nodes within a distance threshold. The cluster 306 may be identified from the connected nodes by performing a connected components analysis (listings 308). In another example, an entity may belong to two clusters. For example, another entity (not shown) located in the portion 300 may belong to both the cluster 302 and cluster 306.

After identifying a cluster of listings, listings within the cluster may be evaluated. For example, an attribute associated with Entity 4 may be compared to the attributes of Entity 1, Entity 2, and Entity 3. For example, if Entity 1, Entity 2, and Entity 3 are residential listings, the “visitability” attribute of Entity 4 may be modified to match the visitability attributes of Entity 4. Similarly, in some embodiments, a category of Entity 4 may be compared to the attributes of Entity 1, Entity 2, and Entity 3. For example, if Entity 1, Entity 3, and Entity 3 are categorized as residential and Entity 4 is categorized as commercial, then Entity 4 may be identified as a suspect listing and flagged for further review. Additionally, in some embodiments the inter-listing relationship is modified based on the cluster. For example, if Entity 8 is a retail entity and Entity 5 is a medical office entity, Entity 8 may be a medical device seller located within Entity 5. Consequently, the inter-listing relationship between Entity 8 and Entity 5 may be updated based on this determination.

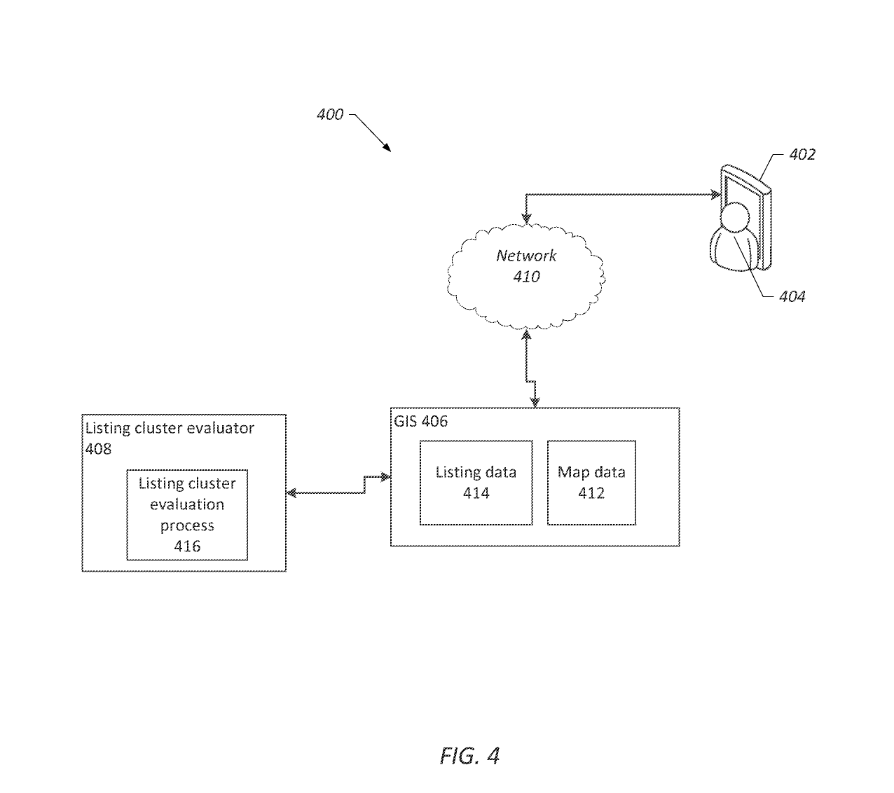

FIG. 4 depicts a system 400 in accordance with an embodiment of the present invention. The system 400 includes a client computer 402 associated with a user 404, a geographic information system 406, a listing cluster evaluator 408, and a network 410. The client computer 402 may include desktop computers, laptop computers, tablet computers, smartphones, personal digital assistants, etc., and may include a receiver for a satellite-based positioning system, such as a Global Positioning System (GPS) receiver. The user 404 may use the client computer 402 to retrieve information, view computer-implemented geographic maps, and perform computer-implemented searches, such as by searching the World Wide Web using a web-based search engine or by searching an computer-implemented geographic maps.

The listing cluster evaluator 408 and the GIS 406 may each be implemented on a single server (in a discrete hardware component or as a virtual server) or multiple servers. The listing cluster evaluator 408 and the GIS 406 may each include web servers, application servers, or other types of servers. Additionally, the listing cluster evaluator 408 and the GIS 406 may each be implemented on servers arranged in any physical and virtual configuration, such as computers in one or more data processing centers, a distributed computing environment, or other configuration. Such configurations may use the network 410 for communication or may communicate over other networks.

The client computer 402 and GIS 406 are in communication with the network 410, such as through a wired or wireless network interface. In some embodiments, the network 410 may include multiple networks, and may include any suitable network and networking technology, such as the Internet, an intranet, a local area network (LAN), a wide area network (WAN), or any other suitable network. Additionally, the network 410 may include a wired network, a wireless network, or both. Moreover, it should be appreciated that the client computer 402 and GIS 406 may communicate over different networks separately and simultaneously. For example, the client computer 402 may communicate over both a wireless Ethernet network and a cellular network.

The GIS 406 includes map data 412 that may be used to provide computer-implemented geographic maps to the user 404 via the client computer 402. For example, in some embodiments, the GIS 406 may include or provide the map data 412 to a web application, a native application, or other application accessed by the client computer 402. The user 404 may use such an application to view and interact with geographic maps generated from the map data 412. The GIS 406 also includes or has access to listing data 414 that is used to provide listing data for display on computer-implemented geographic maps. For example, the listing data 414 may include the name, location, contact information (e.g., phone number), network resources (e.g., website) and other data associated with a listing. In some embodiments, the user 404 executes map queries to search the listing data. Map data and listing data responsive to the user's map queries is provided to the client computer 402. For example, a user may search for various listings, e.g., retail stores, restaurants, doctors or other professionals, and so on, and the search results may be displayed on a computer-implemented geographic map displayed on the client computer 402.

The listing cluster evaluator 408 executes a listing cluster evaluation process 416 that may include the process 100 or process 200 described above. The listing cluster evaluation process 416 may use the listing data 414 and map data 412 from the GIS 406 to determine, for example, clusters of listings and various categories, attributes, and other data associated with listings. For example, using data from the listing data 414 and map data 412, the listing cluster evaluation process 416 may determine a cluster of listings for evaluation and may perform the various evaluations described above. Based on the evaluations, modified listing data may then be provided to the GIS 406. For example, if the listing cluster evaluation process 416 modifies an attribute of an entity based on comparison to other listings of a cluster, the modified attribute may be updated in the listing data 414. Similarly, inter-listing relationships and listing categories may also be updated based on the cluster evaluations described above.

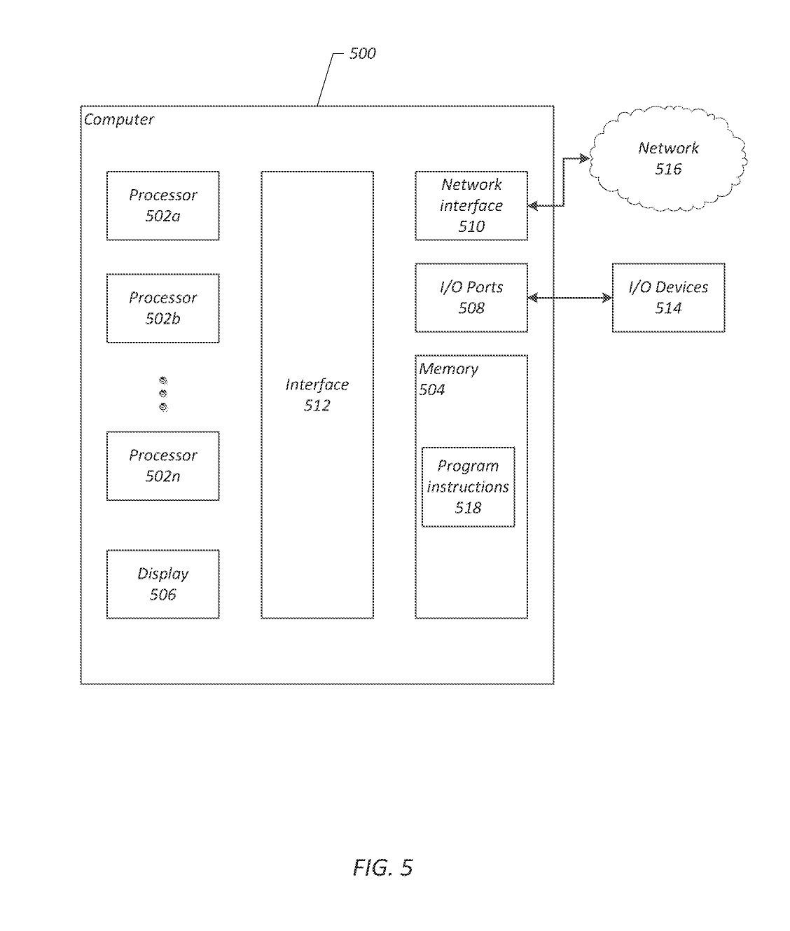

FIG. 5 depicts a computer 500 in accordance with an embodiment of the present invention. Various portions or sections of systems and methods described herein include or are executed on one or more computers similar to computer 500 and programmed as special-purpose machines executing some or all steps of processes described above as executable computer code. Further, processes, modules, and other components described herein may be executed by one or more processing systems similar to that of computer 500.

The computer 500 may include various components that contribute to the function of the device and enable the computer 500 to function in accordance with the techniques discussed herein. As will be appreciated, some components of computer 500 may be provided as internal or integral components of the computer 500 and some components may be provided as external or connectable components. Moreover, FIG. 5 depicts one example of a particular implementation and is intended to illustrate the types of components and functions that may be present in various embodiments of the computer 500.

Computer 500 may include a combination of devices or software that may perform or otherwise provide for the performance of the techniques described herein. For example, computer 500 may include or be a combination of a cloud-computing system, a data center, a server rack or other server enclosure, a server, a virtual server, a desktop computer, a laptop computer, a tablet computer, a mobile telephone, a personal digital assistant (PDA), a media player, a game console, a vehicle-mounted computer, or the like. The computer 500 may be a unified device providing any one of or a combination of the functionality of a media player, a cellular phone, a personal data organizer, a game console, and so forth. Computer 500 may be connected to other devices that are not illustrated or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available. As shown in the embodiment illustrated in FIG. 5, the computer 500 may include one or more processors (e.g., processors 502a-502n), a memory 504, a display 506, I/O ports 508 a network interface 510, and an interface 512. Additionally, the computer 500 may include or be coupled to I/O devices 514.

In addition, the computer 500 may allow a user to connect to and communicate through a network 516 (e.g., the Internet, a local area network, a wide area network, etc.) and, in some embodiments, to acquire data from a satellite-based positioning system (e.g., GPS). For example, the computer 500 may allow a user to communicate using e-mail, text messaging, instant messaging, or using other forms of electronic communication, and may allow a user to obtain the location of the device from a satellite-based positioning system.

In some embodiments, the display 506 may include a liquid crystal display (LCD) an organic light emitting diode (OLED) display, or other display types. The display 506 may display a user interface (e.g., a graphical user interface) executed by the processor 502 of the computer 500. The display 506 may also display various indicators to provide feedback to a user, such as power status, call status, memory status, network status etc. These indicators may be incorporated in the user interface displayed on the display 506. In some embodiments, the display 506 may include or be provided in conjunction with touch sensitive elements through which a user may interact with the user interface. In such embodiments, a touch-sensitive display may be referred to as a “touch screen” and may also be known as or called a touch-sensitive display system.

The processor 502 may provide the processing capability to execute the operating system, programs, user interface, and other functions of the computer 500. The processor 502 may include one or more processors and may include “general-purpose” microprocessors, special purpose microprocessors, such as application-specific integrated circuits (ASICs), or any combination thereof. In some embodiments, the processor 502 may include one or more reduced instruction set (RISC) processors, such as those implementing the Advanced RISC Machine (ARM) instruction set. Additionally, the processor 502 may include single-core processors and multicore processors and may include graphics processors, video processors, and related chip sets. Accordingly, the computer 500 may be a uni-processor system having one processor (e.g., processor 502a), or a multi-processor system having two or more suitable processors (e.g., 502a-502n). Multiple processors may be employed to provide for parallel or sequential execution of the techniques described herein. Processes, such as logic flows, described herein may be performed by the processor 502 executing one or more computer programs to perform functions by operating on input data and generating corresponding output. The processor 502 may receive instructions and data from a memory (e.g., system memory 504).

The memory 504 (which may include one or more tangible non-transitory computer readable storage mediums) may include volatile memory and non-volatile memory accessible by the processor 502 and other components of the computer 500. The memory 504 may store a variety of information and may be used for a variety of purposes. For example, the memory 504 may store executable computer code, such as the firmware for the computer 500, an operating system for the computer 500, and any other programs or other executable code for providing functions of the computer 500. Such executable computer code may include program instructions 518 executable by a processor (e.g., one or more of processors 502a-502n) to implement one or more embodiments of the present invention. Program instructions 518 may include modules of computer program instructions for implementing one or more techniques described herein, such as the processes 100 and 200 described above. Program instructions 518 may include a computer program (which in certain forms is known as a program, software, software application, script, or code). A computer program may be written in a programming language, including compiled or interpreted languages, or declarative or procedural languages. A computer program may include a unit suitable for use in a computing environment, including a stand-alone program, a module, a component, a subroutine, and the like. A computer program may or may not correspond to a file in a file system. A computer program may be stored in a section of a file that holds other computer programs or data (e.g., one or more scripts stored in a markup language document), in a single file dedicated to the program in question, or in multiple coordinated files (e.g., files that store one or more modules, sub programs, or sections of code). A computer program may be deployed to be executed on one or more processors located locally at one site or distributed across multiple remote sites and interconnected by a communication network. Additionally, the memory 504 may be used for buffering or caching during operation of the computer 500.

As mentioned above, the memory 504 may include volatile memory, such as random access memory (RAM). The memory 504 may also include non-volatile memory, such as ROM, flash memory, a hard drive, other suitable optical, magnetic, or solid-state storage mediums or any combination thereof. The memory 504 may store data files such as media (e.g., music and video files), software (e.g., for implementing functions on computer 500), user preference information, payment transaction information, wireless connection information, contact information (e.g., an address book), and any other suitable data.

The interface 512 may include multiple interfaces and may enable communication between various components of the computer 500, the processor 502, and the memory 504. In some embodiments, the interface 512, the processor 502, memory 504, and one or more other components of the computer 500 may be implemented on a single chip, such as a system-on-a-chip (SOC). In other embodiments, these components, their functionalities, or both may be implemented on separate chips. The interface 512 may coordinate I/O traffic between processors 502a-502n, the memory 504, the network interface 510, 514, or any other devices or a combination thereof. The interface 512 may perform protocol, timing or other data transformations to convert data signals from one component (e.g., the memory 504) into a format suitable for use by another component (e.g., processors 502a-502n). The interface 512 may implement various types of interfaces, such as Peripheral Component Interconnect (PCI) interfaces, the Universal Serial Bus (USB) interfaces, Thunderbolt interfaces, Firewire (IEEE-1394) interfaces, and so on.

The computer 500 may also include an input and output port 508 to enable connection of additional devices, such as I/O devices 514. Embodiments of the present invention may include any number of input and output ports 508, including headphone and headset jacks, universal serial bus (USB) ports, Firewire (IEEE-1394) ports, Thunderbolt ports, and AC and DC power connectors. Further, the computer 500 may use the input and output ports to connect to and send or receive data with any other device, such as other portable computers, personal computers, printers, etc.

The computer 500 depicted in FIG. 5 also includes a network interface 510. The network interface 510 may include a wired network interface card (NIC), a wireless (e.g., radio frequency) network interface card, or combination thereof. The network interface 510 may include known circuitry for receiving and sending signals to and from communications networks, such as an antenna system, an RF transceiver, an amplifier, a tuner, an oscillator, a digital signal processor, a modem, a subscriber identity module (SIM) card, memory, and so forth. The network interface 510 may communicate with networks (e.g., network 516), such as the Internet, an intranet, a cellular telephone network, a wide area network (WAN), a local area network (LAN), a metropolitan area network (MAN), or other devices by wired or wireless communication. The communication may use any suitable communications standard, protocol and technology, including Ethernet, Global System for Mobile Communications (GSM), Enhanced Data GSM Environment (EDGE), a 3G network (e.g., based upon the IMT-2000 standard), high-speed downlink packet access (HSDPA), wideband code division multiple access (W-CDMA), code division multiple access (CDMA), time division multiple access (TDMA), a 4G network (e.g., IMT Advanced, Long-Term Evolution Advanced (LTE Advanced), etc.), Bluetooth, Wireless Fidelity (Wi-Fi) (e.g., IEEE 802.11 standards), voice over Internet Protocol (VoIP), Wi-MAX, an email protocol (e.g., Internet message access protocol (IMAP) or post office protocol (POP)), message-oriented protocols (e.g., extensible messaging and presence protocol (XMPP), Multimedia Messaging Service (MMS), Short Message Service (SMS), or any other suitable communications standards, protocols, and technologies.

Various embodiments may further include receiving, sending or storing instructions and/or data implemented in accordance with the foregoing description upon a computer-accessible medium. Generally speaking, a computer-accessible/readable storage medium may include a non-transitory storage media such as magnetic or optical media, (e.g., disk or DVD/CD-ROM), volatile or non-volatile media such as RAM (e.g. SDRAM, DDR, RDRAM, SRAM, etc.), ROM, etc.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” includes a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

What is claimed is:

1. A computer-implemented method for improving entity listings, comprising:
determining, by one or more processors, a cluster of a plurality of listings having geographic proximity;
obtaining, by one or more processors, an attribute associated with a selected listing of the cluster;
comparing, by one or more processors, the attribute of the selected listing to one or more attributes of the other listings of the cluster; and
modifying, by one or more processors, a value of the attribute associated with the selected listing of the cluster based on the comparison.

2. The computer-implemented method of claim 1, wherein the attribute comprises a visitability of the listing, wherein the visitability indicates whether a location of the listing is open to the public for commerce.

3. The computer-implemented method of claim 1, wherein determining, by one or more processors, a cluster of a plurality of listings having geographic proximity comprises:
generating a graph, wherein each node of the graph is associated with one of the plurality of listings;
determining one or more edges between one or more pairs of the plurality of nodes within a distance threshold; and
performing a connected component analysis of the graph to identify the plurality of listings in the cluster.

4. The computer-implemented method of claim 1, comprising:
comparing a category of the selected listing of the cluster to one or more categories of the plurality of other listings of the cluster; and
identifying the selected listing of the cluster as a suspect listing if the category of the selected listing is inconsistent with the one or more categories of the plurality of other listings in the cluster.

5. The computer-implemented method of claim 4, wherein the category comprises residential or commercial.

6. The computer-implemented method of claim 1, comprising modifying an inter-listing relationship between the selected listing of the cluster and a second listing of the cluster based on the distance between the selected listing and the second listing.

7. The computer-implemented method of claim 6, wherein modifying the inter-listing relationship further comprises:
determining a density of the plurality of listings of the cluster; and
modifying, by one or more processors, the inter-listing relationship between the selected listing and the second listing based on the density.

8. A system for improving entity listings, the system comprising:
one or more processors;
a tangible non-transitory computer-readable storage medium accessible by the one or more processors and having executable computer code stored thereon, the code comprising a set of instructions that causes one or more processors to perform the following:
determining, by one or more processors, a cluster of a plurality of listings having geographic proximity;
obtaining, by one or more processors, an attribute associated with a selected listing of the cluster;
comparing, by one or more processors, the attribute of the selected listing to one or more attributes of the other listings of the cluster; and
modifying, by one or more processors, a value of the attribute associated with the selected listing of the cluster based on the comparison.

9. The system of claim 8, wherein the attribute comprises a visitability of the listing, wherein the visitability indicates whether a location of the listing is open to the public for commerce.

10. The system of claim 8, wherein determining, by one or more processors, a cluster of a plurality of listings having geographic proximity comprises:
generating a graph, wherein each node of the graph is associated with one of the plurality of listings;
determining one or more edges between one or more pairs of the plurality of nodes within a distance threshold; and
performing a connected component analysis of the graph to identify the plurality of listings in the cluster.

11. The system of claim 8, the code comprising a set of instructions that causes one or more processors to perform the following:
comparing a category of the selected listing of the cluster to one or more categories of the plurality of other listings of the cluster; and
identifying the selected listing of the cluster as a suspect listing if the category of the selected listing is inconsistent with the one or more categories of the plurality of other listings in the cluster.

12. The system of claim 11, wherein the category comprises residential or commercial.

13. The system of claim 8, the code comprising a set of instructions that causes one or more processors to perform the following modifying an inter-listing relationship between the selected listing of the cluster and a second listing of the cluster based on the distance between the selected listing and the second listing.

14. The system of claim 13, wherein modifying the inter-listing relationship further comprises:
determining a density of the plurality of listings of the cluster; and
modifying, by one or more processors, the inter-listing relationship between the selected listing and the second listing based on the density.

15. A computer-implemented method for improving entity listings, comprising:
determining, by one or more processors, a cluster of a plurality of listings having geographic proximity;
obtaining, by one or more processors, a census of listings in the cluster;
classifying, by one or more processors, the cluster into a class based on the census of listings; and
storing information about each listing in the cluster of listings based on the class of the cluster.

16. The computer-implemented method of claim 15, wherein the class comprises residential, commercial, retail, or medical.

17. The computer-implemented method of claim 15, further comprising:
comparing, by one or more processors, a category of a selected listing of the cluster to the class of the cluster; and
flagging the selected listing for review if the category of the selected listing is inconsistent with the class of the cluster.

18. A system for improving entity listings, the system comprising:
one or more processors;
a tangible non-transitory computer-readable storage medium accessible by the one or more processors and having executable computer code stored thereon, the code comprising a set of instructions that causes one or more processors to perform the following:
determining, by one or more processors, a cluster of a plurality of listings having geographic proximity on a computer-implemented geographic map;
obtaining, by one or more processors, a census of listings in the cluster;
classifying, by one or more processors, the cluster into a class based on the census of listings: and
storing information about each listing in the cluster of listings based on the class of the cluster.

19. The system of claim 18, wherein the class comprises residential, commercial, retail, or medical.

20. The system of claim 18, further comprising:
comparing, by one or more processors, a category of a selected listing of the cluster to the class of the cluster; and
flagging the selected listing for review if the category of the selected listing is inconsistent with the class of the cluster.
